(19) United States
(12) Patent Application Publication
(10) Pub. No.: US 2020/0173845 A1
(43) Pub. Date: Jun. 4, 2020

(54) CHARGE CARRIER MULTIPLIER STRUCTURE

(71) Applicant: The University of Warwick, Coventry (GB)

(72) Inventors: Gavin BELL, Coventry (GB); Yorck Ramachers, Coventry (GB); Raffaello DA CAMPO, Coventry (GB)

(21) Appl. No.: 16/303,726

(22) PCT Filed: May 22, 2017
(86) PCT No.: PCT/GB2017/051429

§ 371 Date: Nov. 21, 2018

(30) Foreign Application Priority Data
May 23, 2016 (GB) 1609007.8

(51) Int. Cl. G01J 1/42; H01J 40/16; G01N 21/33; G01N 21/25

(52) U.S. Cl. CPC G01J 1/429; G01N 21/255; G01N 21/33; H01J 40/16

(57) ABSTRACT

A charge carrier multiplier structure for a light sensor, in particular an ultraviolet light sensor, is described. The charge carrier multiplier structure comprises a dielectric sheet having first and second opposite faces and having an array of holes traversing the dielectric sheet between the first and second faces, at least two photocathodes supported on the first face of the dielectric sheet that are electrically isolated from each other and which define at least two sensing regions, each photocathode having a respective work function and quantum yield and having a respective area and at least one anode supported on the second face of the dielectric sheet.

### FIELD OF THE INVENTION

The present invention relates to a charge carrier multiplier structure, particularly to a charge carrier multiplier structure for sensing ultraviolet light, to a device which includes the charge carrier multiplier structure.

### BACKGROUND

Gaseous electron multipliers are known and reference is made to R. Chechik and A. Breskin: “Advances in gaseous photomultipliers”, Nuclear Instruments and Methods in Physics Research A, volume 595, pages 116 to 127 (2008) and A. Breskin et al.: “A concise review on THGEM detectors”, Nuclear Instruments and Methods in Physics Research A, volume 598, pages 107 to 111 (2009).

R. Chechik and A. Breskin: “Advances in gaseous photomultipliers” ibid. describes a gaseous electron multiplier which is sensitive to ultraviolet (UV) radiation. However, the photomultiplier has a cut-off frequency of 210 nm and so is limited to detecting radiation in the extreme UV range.

WO 2015/150765 A1 describes a UV light sensor which is able to detect radiation in the middle UV range (200-300 nm) and/or at wavelengths in the near UV range (300-400 nm).

### SUMMARY

According to a first aspect of the present invention there is provided a charge carrier multiplier structure. The charge carrier multiplier structure comprises a dielectric sheet having first and second opposite faces and having an array of holes traversing the dielectric sheet between the first and second faces, at least two photocathodes supported on the first face of the dielectric sheet that are electrically isolated from each other and which define at least two sensing regions, each photocathode having a respective work function and quantum yield and having a respective area and at least one anode supported on the second face of the dielectric sheet.

The charge carrier multiplier structure can be used in a sensor to provide spectral discrimination. A single high-voltage source is used for all the sensing regions which is associated with common noise on all channels. Subtracting one signal from another rejects correlated noise which optimises signal-to-noise ratio.

The photocathodes may be responsive to a radiation in a wavelength range of 250 to 400 nm. Thus, the charge carrier multiplier structure may be for ultraviolet sensing.

The product of quantum yield and area are preferably the same for each photocathode. Thus, a difference between two signals from two sensing regions with different work functions can be taken which accurately reflects the spectroscopic intensity between the two wavelengths corresponding to those work functions. Because the two signals are not scaled, the difference signal optimally rejects the common noise on the two channels.

The products of quantum yield and area are preferably the same for each photocathode, and the total illumination intensities divided by the areas are the same for each photocathode. Thus, a difference between two signals from two sensing regions can be taken which both gives true spectroscopic intensity between the two cut-off wavelengths and optimises common noise rejection. A cut-off wavelength is the wavelength corresponding to the cut-off frequency which corresponds to the −3 dB point.

The sensing regions may take the form of circular sectors arranged around a centre. The sensing regions take the form of polygons, for example, which may be rectangles (in plan view). The sensing regions may be arranged in an array.

The charge carrier multiplier structure may comprise three photocathodes.

At least some (e.g. all of the) photocathodes may comprise a surface layer of different materials. At least some (e.g. all of the) photocathodes may comprise a surface layer of an alloy (or other mixture) or a compound consisting of the same elements or substances, but in different proportions. For example, first and second photocathodes may comprise a surface layer of zinc magnesium oxide, but having different magnesium content.

At least some (e.g. all of the) photocathodes may comprise a surface layer comprising the same material having different values of work functions. This may be achieved by using different deposition conditions (for the same material) and/or different post-deposition processes (such as annealing) and/or using surface-modifying layers.

A photocathode may comprise a multi-layer stack comprising two or more layers. The multilayer stack may comprise a base layer and a surface layer. For example, the base layer may be a layer of copper or other metal. The multilayer stack may further comprise a surface-modifying layer on the surface layer for changing the work-function of the surface layer. The multilayer stack may further comprise a protective layer on the surface-layer or surface-modifying layer. The multilayer stack may include one or more intermediate layers between the base layer and surface layer. For example, an intermediate layer may comprise ITO.

The at least two photocathodes may be used for sensing UV light at a given wavelength A and provide spectral discrimination. The at least two photocathodes may comprise a first photocathode having a first cut-off wavelength of in a range (λᵢ−δ₁) nm to λᵢ nm and a second photocathode having a second, cut-off wavelength of in a range λᵢ nm to (λ₁+δ₂) nm, where δ₁ may be at least 5 nm, at least 7 nm, at least 10 nm, at least 15 nm, at least 20 nm at least 30 nm or at least 50 nm and δ₂ may be at least 5 nm, at least 7 nm, at least 10 nm, at least 15 nm, at least 20 nm at least 30 nm or at least 50 nm.

The at least two photocathodes may comprise a first photocathode having a first work function ϕ₁ and a second photocathode having a work function ϕ₂. The difference, Δϕ, in values between the first and second work functions, i.e. |ϕ₁−ϕ₂|, is preferably at least 0.2 eV (which corresponds roughly to a difference in wavelength of about 15 nm).

By not making the range too narrow, a sufficiently high count rate can be achieved. The difference, Δϕ, may be between 0.2 and 0.5 eV which may be used, for example, to provide fine (i.e. narrow) spectral discrimination. The difference, Δϕ, may be between 0.5 and 1 eV which may be used, for example, to provide (wide) spectral discrimination. The difference, Δϕ, may be greater than 1 eV which may be used, for example, to provide broadband UV background discrimination.

At least one photocathode may comprise material listed in Table 2.

The at least two photocathodes may include a first photocathode which is sensitive to UV light at 254 nm. The at least two photocathodes may include a first photocathode or second photocathode which is sensitive to UV light at 309 nm.

The at least two photocathodes may include a first photocathode which comprises silicon germanium. The at least two photocathodes may include a first photocathode or second photocathode which comprises zinc oxide (ZnO) or zinc magnesium oxide (ZnMgO).

The at least two photocathodes may comprise a first photocathode having a first cut-off wavelength of in a range 290 to 340 nm, a second photocathode having a second, different cut-off wavelength of in a range 290 to 340 nm and a third photocathode having a third, different cut-off wavelength of in a range 290 to 340 nm.

The first cut-off wavelength may be 295 nm, the second cut-off wavelength may be 314 nm and the third cut-off frequency is 332 nm. Thus, the charge carrier multiplier structure can be used in a narrow-band flame detector sensor.

The first, second and third photocathodes may comprise zinc oxide or zinc magnesium oxide.

The at least two photocathodes may comprise a first photocathode having a first cut-off wavelength of in a range 240 to 266 nm, a second photocathode having a second, different cut-off wavelength of in a range 240 to 266 nm and a third photocathode having a third, different cut-off wavelength of in a range 240 to 266 nm.

The first, second and third photocathodes may comprise silicon germanium.

The dielectric sheet may have a thickness of at least 0.4 mm or at least 1 mm. The area of each sensing region may be at least 1 cm², at least at least 5 cm², at least 10 cm² or at least at least 50 cm².

The dielectric sheet may be flat.

The dielectric sheet may be curved. The dielectric sheet may be a spherical cap, for example, a hemisphere.

The charge carrier multiplier structure may comprise an array of sensels. Each sensel may include first and second photocathodes having different work functions. The charge carrier multiplier may be provided with an array of baffles, each sensel provided with a respective baffle.

According to a second aspect of the present invention there is provided apparatus comprising a charge carrier multiplier structure, a high-voltage source arranged to apply the same given voltage between each photocathode and the anode and at least two current meters, each current meter arranged to measure current of a respective sensing region.

The given voltage may result in an electric field having a value between 0.5 MVm⁻¹ and 2 MVm⁻¹.

The apparatus may further comprise at least one adder for generating at least one sum signal from at least two current signals. The apparatus may further comprise at least one comparator for generating at least one difference signal from at least two current signals.

According to a third aspect of the present invention there is provided a charge carrier multiplier structure and at least one light source configured to illuminate the charge carrier multiplier.

The apparatus may further comprise at least one light source configured to illuminate the charge carrier multiplier. The apparatus may comprise a plurality of light sources, wherein at least one light source is configured to illuminate a respective sensing region.

According to a fourth aspect of the present invention there is provided apparatus comprising a charge carrier multiplier structure, a light-blocking structure having at least one window aligned with the charge carrier multiplier structure so as to allow light passing through the window(s) to be incident on the charge carrier multiplier and a container or a conduit for a sample interposed between the at least one window and the charge carrier multiplier.

The apparatus may comprise at least one light source and a container or a conduit which is transparent or which includes transparent window(s) interposed between the at least one light source and the charge carrier multiplier.

According to a fifth aspect of the present invention there is provided apparatus comprise comprising a gas-tight housing and a charge carrier multiplier structure.

The apparatus may further comprise gas within the housing. The gas may be at atmospheric pressure (101 kPa). The gas may be at a pressure between 1 Torr (0.13 kPa) and atmospheric pressure (101 kPa). The gas may be a noble gas, such as argon.

According to a fifth aspect of the present invention there is provided a monitoring system comprising the charge carrier multiplier structure or apparatus. The monitoring system may be a fire monitoring system. The monitoring system may be an environmental or chemical monitoring system.

According to a sixth aspect of the present invention there is provided a vehicle comprising the charge carrier multiplier structure or apparatus. The vehicle may be a motor vehicle, such as an automobile. The vehicle may be an aircraft.

### BRIEF DESCRIPTION OF THE DRAWINGS

Certain embodiments of the present invention will now be described, by way of example, with reference to the accompanying drawings, in which:

FIG. 1 is a schematic diagram of a first sensor system;

FIG. 2 is a schematic diagram of a second sensor system;

FIG. 3 is a cross-sectional view of a multi-layer photocathode structure;

FIG. 4 illustrates a water absorption spectrum;

FIG. 5 illustrates a hydrogen combustion spectrum;

FIG. 6 is a plan view of a first charge carrier multiplier structure;

FIG. 7 is a cross-sectional view of the first charge carrier multiplier structure shown in FIG. 1, together with a high-voltage source and current meters;

FIG. 8 is a cross-sectional view of a second carrier multiplier structure, together with a high-voltage source and current meters;

FIGS. 9a, 9b and 9c illustrate different photocathode patterns;

FIG. 10 illustrates a standard pattern of photocathodes which can be selectively wired to provide suitable aggregate areas;

FIG. 11 illustrate a tessellation pattern of photocathodes; and

FIG. 12 is a perspective view of a third charge carrier multiplier structure and a baffle structure.

### DETAILED DESCRIPTION OF CERTAIN EMBODIMENTS

In the following lie parts are denoted using like references.

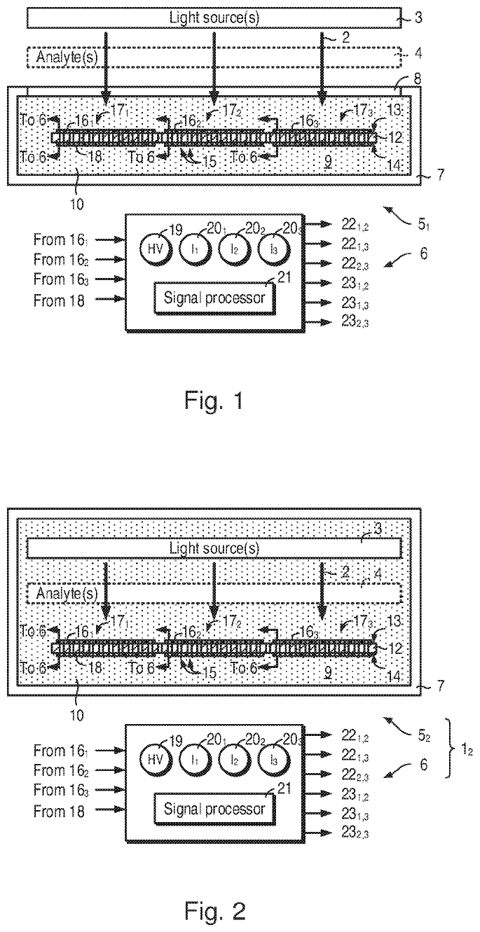

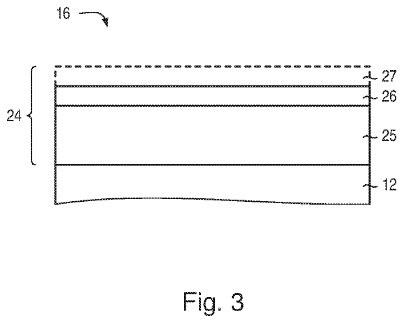

Referring to FIGS. 1 and 2, first and second light-sensing systems 1₁, 1₂ which are capable of spectral discrimination are shown. The light-sensing systems 1₁, 1₂ can be used to sense light 2 from a light source 3 and/or to detect the presence or absence of one or more analytes 4. The light-sensing systems 1₁, 1₂ are sensitive to light 2 in the ultraviolet part of the electromagnetic spectrum, i.e. to light generally up to a wavelength between about 250 nm to 400 nm.

The light-sensing systems 1₁, 1₂ each comprise a light-sensing device 5₁, 5₂ and circuitry 6 for supplying a high voltage to the device 5₁, 5₂, and measuring and processing signals from the device 5₁, 5₂.

Each light-sensing device 5₁, 5₂ comprises a housing 6₁, 6₂ which includes a non-gas permeable enclosure part 7₁, 7₂ and, optionally, a transparent, non-gas permeable window part 8, for example, formed from glass, plastic or other UV transmissive material, which defines a gas-tight sealed chamber 9 and which is filled with an ionisable gas 10. The light-sensing device 5₁, 5₂ comprises a multi-sector charge carrier multiplier structure 11 which is sensitive to ultraviolet light disposed with the housing 6₁, 6₂. The multi-sector charge carrier multiplier structure 11 is herein also referred to as a “multi-sector UV sensor” 11.

The first and second light-sensing systems 1₁, 1₂ are generally the same except that the first light-sensing system 1₁ is arranged to detect light from a light source 3 which is outside the housing 6₁ of the light-sensing device 5₁ and the second light-sensing system 1i is arranged to detect light from a light source 3 which lies inside the housing 6₂ of the light-sensing device 5₂. For example, the first light-sensing system 1₁ may take the form of a flame detector and the second light-sensing system 1₂ may take the form of a water-quality monitoring system. The light intensity per unit provided by the light source(s) 3 is preferably constant.

The light-sensing device 5₁, 5₂ includes a charge generation and separation arrangement which comprises a charge carrier multiplier 11 in the form of a thick gaseous electron multiplier (THGEM). The charge carrier multiplier structure 11 takes the form of a perforated sandwich structure which comprises a dielectric sheet 12 having first and second opposite faces 13, 14 (hereinafter referred to as front and back faces respectively) and having an array of holes 15 traversing the dielectric sheet between the first and second faces. The charge carrier multiplier structure 11 comprises first, second and third photocathodes 16₁, 16₂, 16₃ supported on the first face of the dielectric sheet 12 that are electrically isolated from each other and which define first, second and third sensing regions 17₁, 17₂, 17₃ (herein also referred to as “sectors”). The charge carrier multiplier structure 11 also comprises a common anode 18 supported on the second face 14 of the dielectric sheet 12.

The circuitry 6 includes a high voltage source 19, a set of current meters 20₁, 20₂, 20₃ and a signal processor 21. The photocathode 16₁, 16₂, 16₃ are grounded and the anode 18 is biased positively with respect to the photocathode 16₁, 16₂, 16₃. A bias, V₁, is applied by the high voltage source 19 which applies a bias of about 1 kV to generate an electric field, E, within the holes 15 of about 1 MVm⁻¹.

The circuitry 6 can subtract one channel from another in hardware and/or software, without scaling, to obtain a signal-to-noise-optimised difference signal. The circuitry 6 may be used to add signals in hardware and/or software to obtain a total UV intensity. The circuitry 6 can integrate signal(s) over some time in hardware and/or software to improve signal-to-noise still further (at the expense of time resolution) or to smooth out “spikes”, e.g. arising from camera flash. This can be useful to reject spurious signals, for example, in fire sensing.

The photoelectric effect, i.e. light-to-charge conversion, takes place in the photocathode material. Thus, photons 2 strike a photocathode 16₁, 16₂, 16₃, thereby generating a mobile electron (not shown) which escapes the material and a bound hole (not shown) in the material. The through holes 15 provide channels through which photo-generated charge carriers (not shown) can travel, collide and generate other charge carriers and so generate an avalanche current.

The first, second and third current meters 20₁, 20₂, 20₃ measure the generated photocurrents I₁, I₂, I₃.

The signal processor 20 (which may be implemented in hardware or software) is used to add currents and take differences between currents and output current values sums 22_{1,2}, 22_{1,3}, 22_{2,3} and differences 23_{1,2}, 22_{1,3}, 22_{2,3}.

Details regarding some of the aspects of the charge carrier multiplier 11, such as dimensions and materials used for the dielectric sheet, the materials used for the photocathode and anode, the configuration of the holes, types of ionisable gas and pressures, fabrication and principles of operation can be found in WO 2015/150765A1 which is incorporated herein by reference.

Each photocathode 16₁, 16₂, 16₃ comprises a different material such that each material has a respective work function, ϕ₁, ϕ₂, ϕ₃, and quantum yield Y₁, Y₂, Y₃, and having a respective area A₁, A₂, A₃.

The work functions are selected such that:

ϕ₁<ϕ₂<ϕ₃ (1)

The cut-off frequency is a function of work function and so each photocathode 16₁, 16₂, 16₃ has a different cut-off frequency λ₁, λ₂, λ₃. Thus, if light 2 of a given wavelength λᵢ lies between two cut-off frequencies, then the device is able to detect the light 2 of the given wavelength λᵢ.

The product of quantum yield Y₁, Y₂, Y₃ and area A₁, A₂, A₃ are equal, namely:

Y₁A₁=Y₂A₂=Y₃A₃=k (2)

where k is a constant. This allows signals to be subtracted to give spectroscopic signal discrimination with optimum common noise rejection

The correct amount of one spectrum should be subtracted from another to get a real differential spectrum. With a single HV supply, there will be some noise correlated between all channels. If none of the channels are scaled (i.e. multiplied by some factor) before subtraction, then the subtraction of one signal from another also subtracts the correlated noise thereby improving optimising signal-to-noise. If a channel is scaled, noise is also scaled and so the subtraction is less efficient at common noise rejection.

To measure the intensity of the UV spectrum between two energies defined by two values of work function, the difference is taken between the signals from the two corresponding sectors, i.e. photocathodes 16₁, 16₂, 16₃. All sectors 16₁, 16₂, 16₃ have the same gain because they are all part of the same sensor 11. As explained earlier, to ensure that each sector has equal weighting in the spectrum, area is scaled inversely to quantum efficiency, i.e. A=k/Y, where k is a constant. For example, if a first sector has a first quantum efficiency Y₁ and a first area A₁ and a second sector has a second quantum efficiency Y₂ which is half that of the first sector, i.e. Y₂=Y₁/2, then the second area A₂ should have an area double that of the first area, i.e. A₂=2×A₁.

The wavelength and thus, work function can be chosen to detect specific analytes, which may take the form of chemical species or compounds, or wavelengths.

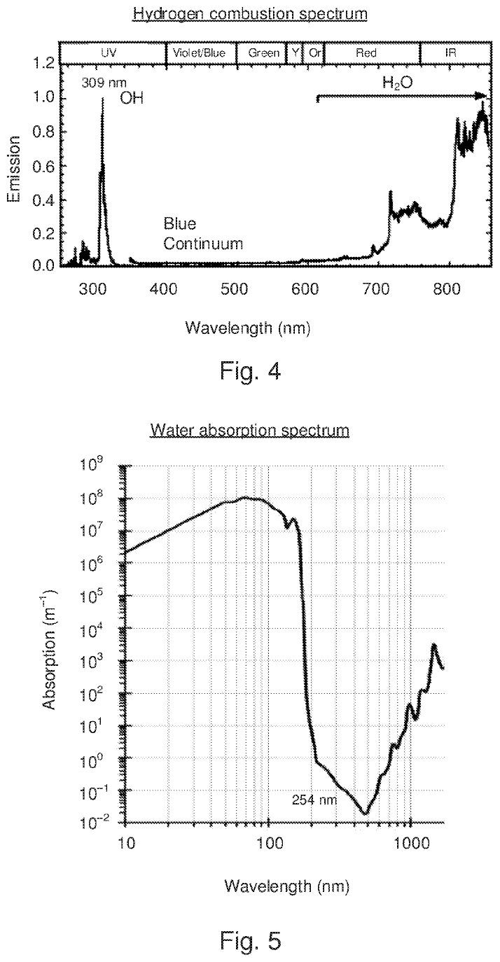

Referring also to FIG. 4, one material which can be used is zinc oxide (ZnO) which can be used to provide a sensitive narrow-band flame detector using the OH emission peak at 309 nm. The sensor may comprise three sectors having cut-off wavelengths 332 nm, 314 nm and 295 nm. An all-ZnO structure can be used by tuning the work function of a ZnO photocathode and a method of tuning of the work function of ZnO by argon sputtering or oxygen plasma treatment is described in F Fang-Ling Kuo, Yun Li, Marvin Solomon, Jincheng Du and Nigel D Shepherd: “Workfunction tuning of zinc oxide films by argon sputtering and oxygen plasma: an experimental and computational study”, Journal of Physics D: Applied Physics, volume 45, page 065301 (2012). This can allow a three-sector sensor to be provided with the sectors having substantially the same quantum efficiency and, thus, having the same area.

Referring also to FIG. 5, another material which can be used is polycrystalline silicon germanium (SiGe). Polycrystalline SiGe can be cheaply and precisely printed using an ink-jet printing process onto ceramic. Polycrystalline SiGe can exhibit a work function in the range of 5.16 eV to 4.67 eV which corresponds to a wavelength in the range 240 nm to 266 nm. Thus, polycrystalline silicon germanium can be used to provide a narrow-band UV254 absorption detector for water quality monitoring. Reference is made to P.-E. Hellberg, S.-L. Zhang and C. S. Petersson: “Work function of boron-doped polycrystalline Si/sub x/Ge/sub 1−x/films”, IEEE Electron Device Letters, volume 18, page 456 (1997).

Table 1 below is a non-exhaustive list of wavelengths, each wavelength given together with its corresponding work function and a potential application:

TABLE 1

| Target | Work | |
|---|---|---|
| wavelength | function | |
| nm | eV | Application |
| 254 | 4.88 | UV254 standard for water monitoring |
| 292 | 4.25 | Hypochlorite contamination |
| 340 | 3.65 | Napthalcne contamination |
| 330 | 3.76 | Mono isopropyl biphenyl contamination |
| 293 | 4.23 | Phenyl xylyl ethane contamination |
| 234 | 5.30 | Cyclopentane contamination |
| 282 | 4.40 | Tetramethyl pentane contamination |
| 240 | 5.17 | Crude oil contamination |
| 260 | 4.77 | Petrobaltic crude oil contamination |
| 260 | 4.77 | Biodiesel - diesel fuel blend |
| 400 | 3.10 | UV400 - (upper wavelength standard for eye |
| | | protection) |
| 309 | 4.01 | Hydrogen flame (OH) |
| 232 | 5.34 | Olive oil grading |
| 270 | 4.59 | Olive oil grading |

Table 2 below is a non-exhaustive list of materials which can be used, each material given together with the work function and corresponding cut off wavelength:

TABLE 2

| | Work | Cut-off |
|---|---|---|
| | function | wavelength |
| Material | eV | nm |
| Cuprous oxide (Cu₂O) | 4.85 | 256 |
| Cu | 4.9 | 253 |
| Ag | 4.53 | 274 |
| ITO | 4.62 | 268 |
| ITO-O plasma treated | 5.16 | 240 |
| Al | 3.4 | 365 |
| ZnO | 4.26 | 291 |
| ZnO on ITO | 4.18 | 297 |
| ZnMgO on ITO (25% Mg) | 3.95 | 314 |
| ZnMgO on ITO (10% Mg) | 4.18 | 297 |
| ZnMgO on ZnO (42% Mg) | 4.2 | 295 |
| ZnMgO on ZnO (10% Mg) | 4.8 | 258 |
| a-Si | 4.7 | 264 |
| a-SiGe (6% Ge) | 3.85 | 322 |
| a-SiGe (49% Ge) | 4.1 | 302 |
| MgO on Mo | 3.2 | 388 |
| MgO on Ag | 3.76 | 330 |
| BaO on Ag | 2 | 620 |

Tabulated values of work functions can usually be varied by between 200 to 500 meV by varying deposition techniques, such as using different spin-coating techniques. It is also possible to control work function for certain materials, such as ZnMgO, by allowing.

The work function of a photocathode can be characterised using contact potential difference measurement. A Kelvin probe can be used, such as a GB050 Kelvin Probe (not shown) available from KP Technology Ltd., Burn Street, Wick, UK. Measurements can be carried out in a glove box (not shown) under inert conditions with mV resolution, high stability, high noise rejection.

A photocathode 16 may comprise a multi-layer structure 24 including of a base layer 25 of metal, such as copper, and a surface layer 26 chosen to provide a specific work function ϕ and, thus, cut-off wavelength λ, and quantum yield Y.

The multi-layer structure 24 may comprise two layers (i.e. be a bi-layer), three layers (i.e. be a tri-layer) or more than three layer structures. The multi-layer structure 24 may comprise a protective layer 27, which is transparent to UV light, on the surface layer 26, for example, to prevent chemical reaction of the underlying surface layer 26.

The charge carrier multiplier structure 11 including the number, geometry and sizes of photocathodes can be varied. Examples of multi-sector UV sensor will now be described.

### Circular Multi-Sector UV Sensor

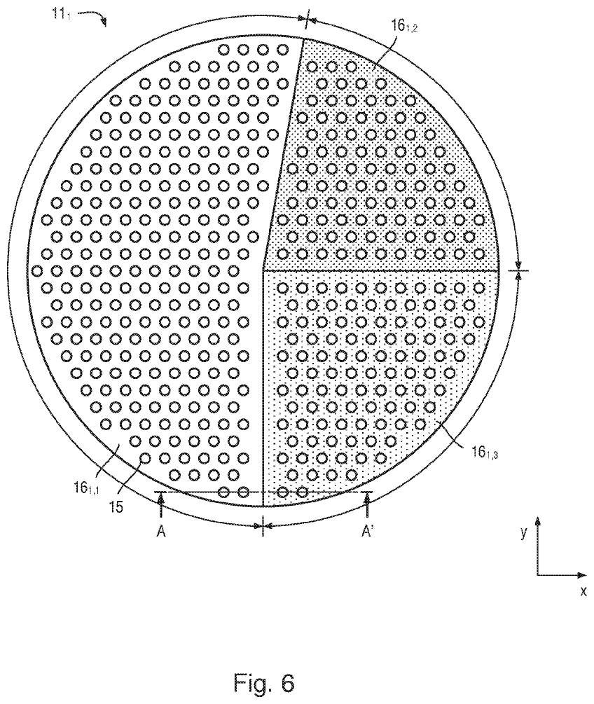

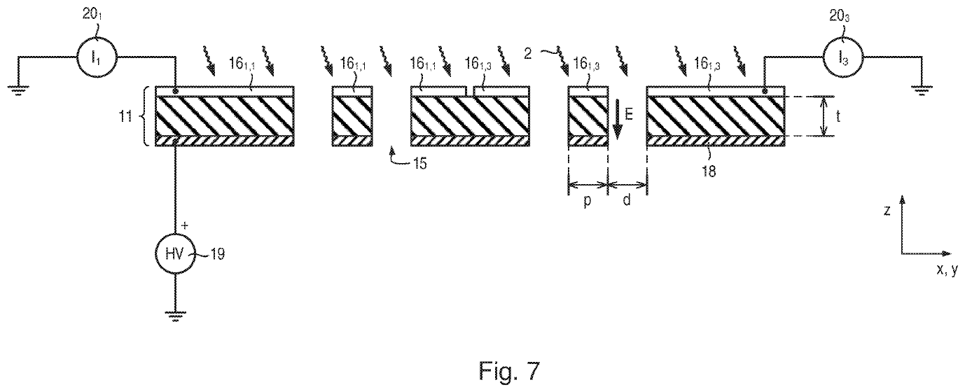

Referring to FIGS. 6 and 7, a first form of multi-sector UV sensor 11, is shown.

The first form of multi-sector UV sensor 11₁ is generally circular in plan view. The front face 13 supports first, second and third sector-shaped photocathode 16_{1,1}, 16_{1,2}, 16_{1,3} which are electrically-isolated from each other.

The areas of the photocathodes 16_{1,1}, 16_{1,2}, 16_{1,3} are chosen so that the product of quantum yield and area are the same.

In this case, the multi-sector UV sensor 11₁ has three sectors, i.e. three photocathodes 16_{1,1}, 16_{1,2}, 16_{1,3}. There may, however, be two sectors or four of more sectors.

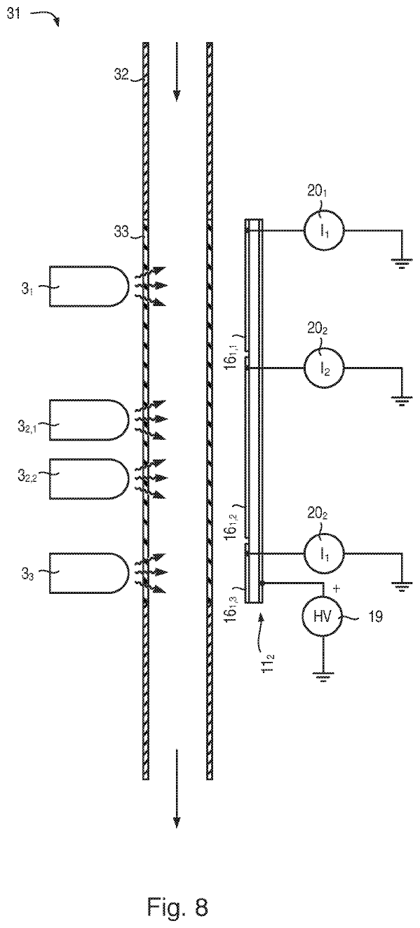

Linear multi-sector UV sensor Referring to FIG. 8, a second form of multi-sector UV sensor 11₂ is shown.

The second form of multi-sector UV sensor 11₂ is generally rectangular in plan view.

The front face 13 supports first, second and third rectangular photocathode 16_{2,1}, 16_{2,2}, 16_{2,3} which are arranged in a line and which are electrically-isolated from each other.

FIG. 6 shown an arrangement 31 in which the sensor 111, is used for absorption measurement for water quality monitoring.

Water flows through a channel 32 (e.g. a pipe) having a section 33 which is transparent to UV light and a constant, high transmission coefficient across the wavelengths being detected. The section 33 may be formed from quartz or other suitable material. Three set of light emitting diodes 3₁, 3_{2,1}, 3_{2,2}, 3₃ are arranged on one side of the transparent section 33 and the multi-sector UV sensor 11₂ is arranged on the other side.

Each set of light emitting diodes 3₁, 3_{2,1}, 3_{2,2}, 3₃ emits light a different characteristic wavelength and is aligned to illuminate a corresponding sector 16_{1,1}, 16_{1,2}, 16_{1,3} of the sensor.

Each wavelength is chosen to be just above key thresholds for UV absorption by particular contaminants and/or at UV254 standard. If a contaminant level rises, then there will be a corresponding drop in signal intensity for any sector 16_{1,1}, 16_{1,2}, 16_{1,3} with threshold lower than the absorption threshold. Thus, the sensor has chemical sensitivity.

Opaque contaminants (e.g. particulates) will reduce the intensity in all sectors, reducing false-positive alarms.

### Multi-Sector Arrangements

Referring to FIGS. 1 and 2, two or more photocathodes 16₁, 16₂, 16₃ can be arranged in different patterns. Using different patterns, especially using patterns which spreads a given photocathode over a larger area (without increasing surface area) and/or which interlock with another photocathode, can be used to help ensure even distribution of incident light UV. Patterns are not limited to rectangles and sectors, but can be regular polygons, e.g. hexagons, irregular polygons or circular or elliptical.

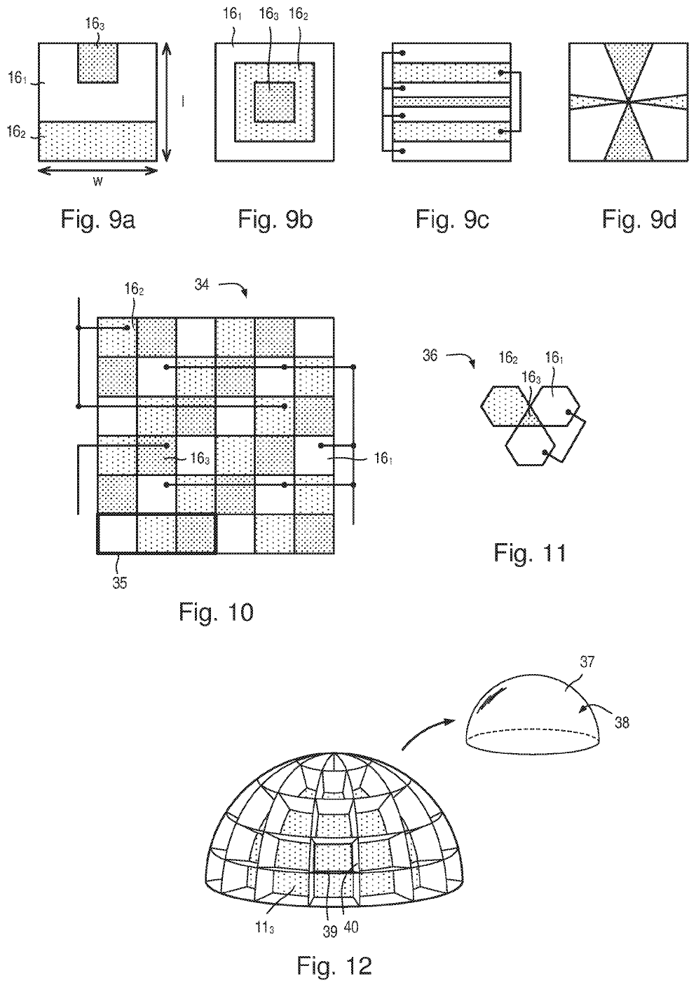

Referring also to FIG. 9a, the photocathodes 16₁, 16₂, 16₃ need not be arranged in sequence with a common dimension (e.g. width). For example, if the charge carrier multiplier structure 11 is rectangular having a width, w, and length, l, the photocathodes 16₁, 16₂, 16₃ need not all have the same width.

Referring to FIG. 9b, at least one photocathode 16₁, 16₂, 16₃ may be surrounded by another photocathode 16₁, 16₂, 16₃, i.e. nested. Two or more photocathode 16₁, 16₂, 16₃ may be nested.

Referring to FIG. 9c, a photocathode 16₁, 16₂, 16₃ of divided into two or more regions which are electrically connected.

Referring to FIG. 9d, the photocathodes 16₁, 16₂, 16₃ may have rotational symmetry.

Referring to FIG. 10, a customisable (or “standard”) photocathode structure 34 may be used in which there is an array of groups 35 of photocathodes elements, each group having one or more preferably two or more, different elements having different work functions, each element having the same area.

For a given photocathode structure 34, a given number of elements having the same work function are connected so as to achieve the desired area.

This can help avoid the need for redesigning the pattern for a sensor having a new combination of work functions. Instead, once the work functions are known, the required areas can be calculated and the correct number of elements can be connected, for example, by blowing a set of fuses (not shown) or anti-fuses (not shown).

Referring to FIG. 11, tessellation pattern 36 may be used comprising shapes of different shapes and sizes, e.g. hexagons and triangles.

Referring to FIG. 9, a UV sensor 11₃ need not be a flat, but can be curved, for example, cylindrical or hemispherical.

The UV sensor 11₃ may comprise a dielectric dome 37 comprising, for example, fused silica which perforated with holes (not shown). The inner surface (not shown) is coated with a metal, such as copper, to provide a common anode and the outer surface 38 supports and array of photocathode sectors 39 which may comprise one, two, three or more photocathodes of different work functions. The array may be arranged into sectors, longitudinally and latitudinally

Each photocathode sector 39 can be provided with a baffle 40 so that only directly incident UV light can reach the sectors.

Such a sensor can be used for motion, fire or other form of sensing in 360°. Signals from different sectors may be measured and timed and so obtain spatiotemporal information about the UV light.

### Other Applications

A UV sensor, such as the UV multi-sector UV sensor, can be used in different applications.

For example, as mentioned earlier, a UV-based sensor can be used for fire detection. As also mentioned earlier, a UV-based sensor can be used in environmental monitoring, for example, for monitoring water or air quality.

A UV-based sensor non-line-of-sight communication can be used a receiver.

UV-based sensors can be used in automotive applications. For example, a UV-based sensor may be used as a local ground albedo detector. Such a detector can be used to sense the presence of ice and, thus, be used for ice warning. Also, such a detector may be used in range finding. Long and medium wave UV light (UVA and UVB), for example in the range of 330 to 340 nm, can penetrate fog and so can be used in collision avoidance. Furthermore, a UV-based sensor can be used to monitor gases, e.g. exhaust gas, for pollutants and/or products of incomplete combustion.

UV-based sensors may be used in aerospace applications, for example, to detect clear air turbulence (CAT).

### Modifications

It will be appreciated that many modifications may be made to the embodiments hereinbefore described. Such modifications may involve equivalent and other features which are already known in the design, manufacture and use of UV sensors and/or TGHEM and/or parts thereof and which may be used instead of or in addition to features already described herein. Features of one embodiment may be replaced or supplemented by features of another embodiment.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1. A charge carrier multiplier structure comprising:
a dielectric sheet having first and second opposite faces and having an array of holes traversing the dielectric sheet between the first and second faces,
at least two photocathodes supported on the first face of the dielectric sheet that are electrically isolated from each other and which define at least two sensing regions, each photocathode having a respective work function and quantum yield and having a respective area; and
an anode supported on the second face of the dielectric sheet.

2. A charge carrier multiplier structure according to claim 1, wherein the product of quantum yield and area is the same for each photocathode.

3. A charge carrier multiplier structure according to claim 1, wherein the sensing regions take the form of circular sectors arranged around a centre.

4. A charge carrier multiplier structure according to claim 1, wherein the sensing regions take the form of polygons.

5. A charge carrier multiplier structure according to claim 4, wherein the polygons are rectangles.

6. A charge carrier multiplier structure according to claim 1, wherein the sensing regions are arranged in an array.

7. A charge carrier multiplier structure according to claim 1, comprising three photocathodes.

8. A charge carrier multiplier structure according to claim 1, wherein the at least two photocathodes comprise a first photocathode having a first work function ϕ₁ and a second photocathode having a work function ϕ₂, wherein the difference Δϕ in values between the first and second work functions is at least 0.2 eV.

9. (canceled)

10. A charge carrier multiplier structure according to claim 1, wherein the at least two photocathodes include a first photocathode which comprises silicon germanium.

11. (canceled)

12. A charge carrier multiplier structure according to claim 1, wherein the at least two photocathodes include a first photocathode or second photocathode which comprises zinc oxide.

13-17. (canceled)

18. A charge carrier multiplier structure according to claim 1, wherein the dielectric sheet is curved.

19. (canceled)

20. A charge carrier multiplier structure according to claim 1; wherein the charge carrier multiplier structure is formed as an apparatus, wherein the apparatus further includes:
a high voltage source arranged to apply the same given voltage between each photocathode and the anode; and
at least two current meters, each current meter arranged to measure current of a respective sensing region.

21. A charge carrier multiplier structure according to claim 20, further comprising:
at least one adder for generating at least one sum signal from at least two current signals.

22. A charge carrier multiplier structure according to claim 20, further comprising:
at least one comparators for generating at least one difference signal from at least two current signals.

23. A charge carrier multiplier structure according to claim 1; and
at least one light source configured to illuminate the charge carrier multiplier structure.

24-27. (canceled)

28. A charge carrier multiplier structure according to claim 1 disposed within the housing,
wherein the charge carrier multiplier structure is formed as an apparatus, wherein the apparatus further includes.

29. (canceled)

30. A charge carrier multiplier structure to claim 28, further comprising gas within the housing.

31. (canceled)

32. A charge carrier multiplier structure according to claim 30, wherein the gas is at a pressure between 1 Torr (0.13 kPa) and atmospheric pressure (101 kPa).

33. A charge carrier multiplier structure according to claim 30, wherein the gas is a noble gas.

34. A charge carrier multiplier structure according to claim 1, wherein the charge carrier multiplier structure is formed as part of a monitoring system.

35. (canceled)
